(19) United States
(12) Patent Application Publication
(10) Pub. No.: US 2023/0144912 A1
(43) Pub. Date: May 11, 2023

(54) METAL-BASED CATALYST FOR PRODUCING POLYDIENES

(71) Applicant: Bridgestone Americas Tire Operations, LLC, Nashville, TN (US)

(72) Inventors: Steven M. BALDWIN, Akron, OH (US); James KUHEL, III, Stow, OH (US); Terrence E. HOGAN, Uniontown, OH (US)

(21) Appl. No.: 17/915,922

(22) PCT Filed: Mar. 31, 2021
(86) PCT No.: PCT/US2021/025080

§ 371 Date: Sep. 29, 2022

Related U.S. Application Data
(60) Provisional application No. 63/002,407, filed on Mar. 31, 2020.

(51) Int. Cl. C08F 136/06; C08F 4/54; C08F 4/70; B60C 1/00

(52) U.S. Cl. CPC C08F 136/06; C08F 4/545; C08F 4/7098; B60C 1/0016; B60C 1/0025

(57) ABSTRACT

A method for preparing a polymer, the method comprising polymerizing conjugated diene monomer in the presence of a lanthanide-based catalyst system including (i) a lanthanide-containing compound, (ii) triethyl aluminum, (iii) an aluminum hydride, and (iv) a halogen-containing compound; or a method for preparing a polymer, the method comprising polymerizing conjugated diene monomer in the presence of a lanthanide-based catalyst system including (i) a nickel-containing compound, (ii) triethyl aluminum, (iii) an aluminum hydride, and (iv) a halogen-containing compound selected from fluorine-containing compounds and chlorine-containing compounds.

This application claims the benefit of U.S. Provisional Application Ser. No. 63/002,407 filed on Mar. 31, 2020 which is incorporated herein by reference.

### FIELD OF THE INVENTION

One or more embodiments of the present invention relate to a method for polymerizing conjugated dienes with a metal-based catalyst system.

### BACKGROUND OF THE INVENTION

Synthetic elastomers having a linear backbone are often employed in the manufacture of tire components, such as sidewalls and treads. It is believed that these polymers provide advantageous tensile properties, abrasion resistance, low hysteresis, and fatigue resistance. For example, cis-1,4-polydienes have been used in tires.

Cis-1,4-polydienes can be produced by using lanthanide-based catalyst systems or nickel-based catalyst systems. Lanthanide-based catalyst systems typically include a lanthanide-based compound, an alkylating agent, and source of halogen to activate the system. Nickel-based catalyst systems typically include a nickel-containing compound, an alkylating agent, and a source of halogen to activate the system. Alkyl aluminum compounds, such as trialkyl aluminum compounds and alkylaluminum hydrides, are often employed as an alkylating agent. The species chosen for each component, their relative concentration, and many other factors can impact the polymerization process and the resulting polydiene that is ultimately synthesized. For example, it is known that triisobutylaluminum yields higher monomer conversion and higher cis-1,4-microstructure content than when triethylaluminum is used as an alkylating agent within lanthanide-based systems.

### SUMMARY OF THE INVENTION

One or more embodiments of the present invention provide a method for preparing a polymer, the method comprising polymerizing conjugated diene monomer in the presence of a lanthanide-based catalyst system including a lanthanide-containing compound, triethyl aluminum, an aluminum hydride, and a halogen-containing compound.

Yet other embodiments of the present invention provide a polymer prepared by the steps of polymerizing conjugated diene monomer in the presence of a lanthanide-based catalyst system including a lanthanide-containing compound, triethyl aluminum, an aluminum hydride, and a halogen-containing compound.

Other embodiments of the present invention provide a method for preparing a polymer, the method comprising polymerizing conjugated diene monomer in the presence of a metal-based catalyst system including a nickel-containing compound, triethyl aluminum, an aluminum hydride, and a halogen-containing compound selected from fluorine-containing compounds and chlorine-containing compounds.

Still other embodiments of the present invention provide a polymer prepared by the steps of polymerizing conjugated diene monomer in the presence of a metal-based catalyst system including a nickel-containing compound, triethyl aluminum, an aluminum hydride, and a halogen-containing compound.

### DETAILED DESCRIPTION OF ILLUSTRATIVE EMBODIMENTS

Embodiments of the invention are based, at least in part, on the discovery of a process for the polymerization of conjugated dienes that employs a metal-based catalyst system including triethylaluminum and an aluminum hydride as alkylating agents. The use of this particular alkylating agent combination has unexpectedly produced advantageous results including improved polymerization activity and advantageous polymer properties. While the prior art teaches that the use of triethylaluminum as an alkylating agent results in lower polymerization activity than other commonly used trialkyl aluminum compounds (e.g. triisobutylaluminum), the discoveries associated with the present invention show that the combination of triethylaluminum and aluminum hydride yield particularly advantageous results relative to other alkylating agents, such as triisobutylaluminum, especially with regard to the polymerization activity of lanthanide-based catalysts and the resulting polymer properties. Other embodiments are based, at least in part, on the discovery of a process for the polymerization of conjugated dienes that employs a nickel-based catalyst system including triethylaluminum and an aluminum hydride as alkylating agents. This particular alkylating agent combination also offers advantages over alkylating agents conventionally employed with these catalyst systems.

A first set of embodiments provides a polymerization process whereby conjugated diene monomer is polymerized in the presence of a lanthanide-based catalyst system that includes (i) a lanthanide-containing compound, (ii) triethylaluminum, (iii) an aluminum hydride, and (iv) a halogen-containing compound. In one or more embodiments, other organometallic compounds, Lewis bases, and/or catalyst modifiers can be employed in addition to the ingredients or components set forth above.

A second set of embodiments provides a polymerization process whereby conjugated diene monomer is polymerized in the presence of a nickel-based catalyst system that includes (i) a nickel-containing compound, (ii) triethylaluminum, (iii) an aluminum hydride, and (iv) a halogen-containing compound selected from chlorine-containing and fluorine-containing compounds. In one or more embodiments, other organometallic compounds, Lewis bases, and/or catalyst modifiers can be employed in addition to the ingredients or components set forth above.

### Lanthanide-Containing Compound

Lanthanide-containing compounds useful in the lanthanide-based catalyst systems include those compounds that include at least one atom of lanthanum, neodymium, cerium, praseodymium, promethium, samarium, europium, gadolinium, terbium, dysprosium, holmium, erbium, thulium, ytterbium, lutetium, and didymium. In one embodiment, these compounds can include neodymium, lanthanum, samarium, or didymium. As used herein, the term “didymium” shall denote a commercial mixture of rare-earth elements obtained from monazite sand. In addition, the lanthanide-containing compounds useful in the present invention can be in the form of elemental lanthanide.

The lanthanide atom in the lanthanide-containing compounds can be in various oxidation states including, but not limited to, the 0, +2, +3, and +4 oxidation states. In one embodiment, a trivalent lanthanide-containing compound, where the lanthanide atom is in the +3 oxidation state, can be employed. Suitable lanthanide-containing compounds include, but are not limited to, lanthanide carboxylates, lanthanide organophosphates, lanthanide organophosphonates, lanthanide organophosphinates, lanthanide carbamates, lanthanide dithiocarbamates, lanthanide xanthates, lanthanide β-diketonates, lanthanum oxides, lanthanide alkoxides or aryloxides, lanthanide halides, lanthanide pseudo-halides, lanthanide oxyhalides, and organolanthanide compounds.

In one or more embodiments, the lanthanide-containing compounds can be soluble in hydrocarbon solvents such as aromatic hydrocarbons, aliphatic hydrocarbons, or cycloaliphatic hydrocarbons. Hydrocarbon-insoluble lanthanide-containing compounds, however, may also be useful in the present invention, as they can be suspended in the polymerization medium to form the catalytically active species.

For ease of illustration, further discussion of useful lanthanide-containing compounds will focus on neodymium compounds, although those skilled in the art will be able to select similar compounds that are based upon other lanthanide metals.

Suitable neodymium carboxylates include, but are not limited to, neodymium formate, neodymium acetate, neodymium acrylate, neodymium methacrylate, neodymium valerate, neodymium gluconate, neodymium citrate, neodymium fumarate, neodymium lactate, neodymium maleate, neodymium oxalate, neodymium 2-ethylhexanoate, neodymium neodecanoate (a.k.a., neodymium versatate), neodymium naphthenate, neodymium stearate, neodymium oleate, neodymium benzoate, and neodymium picolinate.

Suitable neodymium organophosphates include, but are not limited to, neodymium dibutyl phosphate, neodymium dipentyl phosphate, neodymium dihexyl phosphate, neodymium diheptyl phosphate, neodymium dioctyl phosphate, neodymium bis(1-methylheptyl) phosphate, neodymium bis(2-ethylhexyl) phosphate, neodymium didecyl phosphate, neodymium didodecyl phosphate, neodymium dioctadecyl phosphate, neodymium dioleyl phosphate, neodymium diphenyl phosphate, neodymium bis(p-nonylphenyl) phosphate, neodymium butyl(2-ethylhexyl) phosphate, neodymium (1-methylheptyl) (2-ethylhexyl) phosphate, and neodymium (2-ethylhexyl) (p-nonylphenyl) phosphate.

Suitable neodymium organophosphonates include, but are not limited to, neodymium butyl phosphonate, neodymium pentyl phosphonate, neodymium hexyl phosphonate, neodymium heptyl phosphonate, neodymium octyl phosphonate, neodymium (1-methylheptyl) phosphonate, neodymium (2-ethylhexyl) phosphonate, neodymium decyl phosphonate, neodymium dodecyl phosphonate, neodymium octadecyl phosphonate, neodymium oleyl phosphonate, neodymium phenyl phosphonate, neodymium (p-nonylphenyl) phosphonate, neodymium butyl butylphosphonate, neodymium pentyl pentylphosphonate, neodymium hexyl hexylphosphonate, neodymium heptyl heptylphosphonate, neodymium octyl octylphosphonate, neodymium (1-methylheptyl) (1-methylheptyl) phosphonate, neodymium (2-ethylhexyl) (2-ethylhexyl)phosphonate, neodymium decyl decylphosphonate, neodymium dodecyl dodecylphosphonate, neodymium octadecyl octadecylphosphonate, neodymium oleyl oleylphosphonate, neodymium phenyl phenylphosphonate, neodymium (p-nonylphenyl) (p-nonylphenyl)phosphonate, neodymium butyl(2-ethylhexyl)phosphonate, neodymium (2-ethylhexyl) butylphosphonate, neodymium (1-methylheptyl) (2-ethylhexyl) phosphonate, neodymium (2-ethylhexyl) (1-methylheptyl) phosphonate, neodymium (2-ethylhexyl) (p-nonylphenyl)phosphonate, and neodymium (p-nonylphenyl) (2-ethylhexyl) phosphonate.

Suitable neodymium organophosphinates include, but are not limited to, neodymium butylphosphinate, neodymium pentylphosphinate, neodymium hexylphosphinate, neodymium heptylphosphinate, neodymium octylphosphinate, neodymium (1-methylheptyl)phosphinate, neodymium (2-ethylhexyl) phosphinate, neodymium decylphosphinate, neodymium dodecylphosphinate, neodymium octadecylphosphinate, neodymium oleylphosphinate, neodymium phenylphosphinate, neodymium (p-nonylphenyl)phosphinate, neodymium dibutylphosphinate, neodymium dipentylphosphinate, neodymium dihexylphosphinate, neodymium diheptylphosphinate, neodymium dioctylphosphinate, neodymium bis(1-methylheptyl)phosphinate, neodymium bis(2-ethylhexyl)phosphinate, neodymium didecylphosphinate, neodymium didodecylphosphinate, neodymium dioctadecylphosphinate, neodymium dioleylphosphinate, neodymium diphenylphosphinate, neodymium bis(p-nonylphenyl) phosphinate, neodymium butyl(2-ethylhexyl) phosphinate, neodymium (1-methylheptyl) (2-ethylhexyl) phosphinate, and neodymium (2-ethylhexyl) (p-nonylphenyl) phosphinate.

Suitable neodymium carbamates include, but are not limited to, neodymium dimethylcarbamate, neodymium diethylcarbamate, neodymium diisopropylcarbamate, neodymium dibutylcarbamate, and neodymium dibenzylcarbamate.

Suitable neodymium dithiocarbamates include, but are not limited to, neodymium dimethyldithiocarbamate, neodymium diethyldithiocarbamate, neodymium diisopropyldithiocarbamate, neodymium dibutyldithiocarbamate, and neodymium dibenzyldithiocarbamate.

Suitable neodymium xanthates include, but are not limited to, neodymium methylxanthate, neodymium ethylxanthate, neodymium isopropylxanthate, neodymium butylxanthate, and neodymium benzylxanthate.

Suitable neodymium β-diketonates include, but are not limited to, neodymium acetylacetonate, neodymium trifluoroacetylacetonate, neodymium hexafluoroacetylacetonate, neodymium benzoylacetonate, and neodymium 2,2,6,6-tetramethyl-3,5-heptanedionate.

Suitable neodymium alkoxides or aryloxides include, but are not limited to, neodymium methoxide, neodymium ethoxide, neodymium isopropoxide, neodymium 2-ethylhexoxide, neodymium phenoxide, neodymium nonylphenoxide, and neodymium naphthoxide.

Suitable neodymium halides include, but are not limited to, neodymium fluoride, neodymium chloride, neodymium bromide, and neodymium iodide. Suitable neodymium pseudo-halides include, but are not limited to, neodymium cyanide, neodymium cyanate, neodymium thiocyanate, neodymium azide, and neodymium ferrocyanide. Suitable neodymium oxyhalides include, but are not limited to, neodymium oxyfluoride, neodymium oxychloride, and neodymium oxybromide. Neodymium oxide may also be used. A Lewis base, such as tetrahydrofuran (“THF”), may be employed as an aid for solubilizing this class of neodymium compounds in inert organic solvents. Where lanthanide halides, lanthanide oxyhalides, or other lanthanide-containing compounds containing a halogen atom are employed, the lanthanide-containing compound may optionally also provide all or part of the halogen source in the lanthanide-based catalyst system.

As used herein, the term organolanthanide compound refers to any lanthanide-containing compound containing at least one lanthanide-carbon bond. These compounds are predominantly, though not exclusively, those containing cyclopentadienyl (“Cp”), substituted cyclopentadienyl, allyl, and substituted allyl ligands. Suitable organolanthanide compounds include, but are not limited to, Cp₃Ln, Cp₂LnR, Cp₂LnCl, CpLnCl₂, CpLn(cyclooctatetraene), (C₅Me₅)₂LnR, LnR₃, Ln(allyl)₃, and Ln(allyl)₂Cl, where Ln represents a lanthanide atom, and R represents a hydrocarbyl group. In one or more embodiments, hydrocarbyl groups useful in the present invention may contain heteroatoms such as, for example, nitrogen, oxygen, boron, silicon, sulfur, and phosphorus atoms.

### Nickel-Containing Compound

Various nickel-containing compounds or mixtures thereof can be employed in the nickel-based catalyst systems. In one or more embodiments, these nickel-containing compounds may be soluble in hydrocarbon solvents such as aromatic hydrocarbons, aliphatic hydrocarbons, or cycloaliphatic hydrocarbons. In other embodiments, hydrocarbon-insoluble nickel-containing compounds, which can be suspended in the polymerization medium to form catalytically active species, may also be useful.

The nickel atom in the nickel-containing compounds can be in various oxidation states including but not limited to the 0, +2, +3, and +4 oxidation states. Nickel-containing compounds include, but are not limited to, nickel carboxylates, nickel carboxylate borates, nickel organophosphates, nickel organophosphonates, nickel organophosphinates, nickel carbamates, nickel dithiocarbamates, nickel xanthates, nickel β-diketonates, nickel alkoxides or aryloxides, nickel halides, nickel pseudo-halides, nickel oxyhalides, and organonickel compounds.

Nickel carboxylates can include nickel formate, nickel acetate, nickel acetate, nickel acrylate, nickel methacrylate, nickel valerate, nickel gluconate, nickel citrate, nickel fumarate, nickel lactate, nickel maleate, nickel oxalate, nickel 2-ethylhexanoate, nickel neodecanoate, nickel naphthenate, nickel stearate, nickel oleate, nickel benzoate, and nickel picolinate.

Nickel carboxylate borates may include compounds defined by the formulae (RCOONiO)₃B or (RCOONiO)₂B(OR), where each R, which may be the same or different, is a hydrogen atom or a mono-valent organic group. In one embodiment, each R may be a hydrocarbyl group such as, but not limited to, alkyl, cycloalkyl, substituted cycloalkyl, alkenyl, cycloalkenyl, substituted cycloalkenyl, aryl, substituted aryl, aralkyl, alkaryl, allyl, and alkynyl groups, with each group preferably containing from 1 carbon atom, or the appropriate minimum number of carbon atoms to form the group, up to about 20 carbon atoms. These hydrocarbyl groups may contain heteroatoms such as, but not limited to, nitrogen, oxygen, silicon, sulfur, and phosphorus atoms. Nickel carboxylate borate may include those disclosed in U.S. Pat. No. 4,522,988, which is incorporated herein by reference. Specific examples of nickel carboxylate borate include nickel(II) neodecanoate borate, nickel(II) hexanoate borate, nickel(II) naphthenate borate, nickel(II) stearate borate, nickel(II) octoate borate, nickel(II) 2-ethylhexanoate borate, and mixtures thereof.

Nickel organophosphates can include nickel dibutyl phosphate, nickel dipentyl phosphate, nickel dihexyl phosphate, nickel diheptyl phosphate, nickel dioctyl phosphate, nickel bis(1-methylheptyl) phosphate, nickel bis(2-ethylhexyl) phosphate, nickel didecyl phosphate, nickel didodecyl phosphate, nickel dioctadecyl phosphate, nickel dioleyl phosphate, nickel diphenyl phosphate, nickel bis(p-nonylphenyl) phosphate, nickel butyl(2-ethylhexyl) phosphate, nickel (1-methylheptyl) (2-ethylhexyl) phosphate, and nickel (2-ethylhexyl) (p-nonylphenyl) phosphate.

Nickel organophosphonates can include nickel butyl phosphonate, nickel pentyl phosphonate, nickel hexyl phosphonate, nickel heptyl phosphonate, nickel octyl phosphonate, nickel (1-methylheptyl) phosphonate, nickel (2-ethylhexyl) phosphonate, nickel decyl phosphonate, nickel dodecyl phosphonate, nickel octadecyl phosphonate, nickel oleyl phosphonate, nickel phenyl phosphonate, nickel (p-nonylphenyl) phosphonate, nickel butyl butylphosphonate, nickel pentyl pentylphosphonate, nickel hexyl hexylphosphonate, nickel heptyl heptylphosphonate, nickel octyl octylphosphonate, nickel (1-methylheptyl) (1-methylheptyl) phosphonate, nickel (2-ethylhexyl) (2-ethylhexyl)phosphonate, nickel decyl decylphosphonate, nickel dodecyl dodecylphosphonate, nickel octadecyl octadecylphosphonate, nickel oleyl oleylphosphonate, nickel phenyl phenylphosphonate, nickel (p-nonylphenyl) (p-nonylphenyl)phosphonate, nickel butyl(2-ethylhexyl)phosphonate, nickel (2-ethylhexyl) butylphosphonate, nickel (1-methylheptyl) (2-ethylhexyl)phosphonate, nickel (2-ethylhexyl) (1-methylheptyl) phosphonate, nickel (2-ethylhexyl) (p-nonylphenyl)phosphonate, and nickel (p-nonylphenyl) (2-ethylhexyl)phosphonate.

Nickel organophosphinates can include nickel butylphosphinate, nickel pentylphosphinate, nickel hexylphosphinate, nickel heptylphosphinate, nickel octylphosphinate, nickel (1-methylheptyl)phosphinate, nickel (2-ethylhexyl)phosphinate, nickel decylphosphinate, nickel dodecylphosphinate, nickel octadecylphosphinate, nickel oleylphosphinate, nickel phenylphosphinate, nickel (p-nonylphenyl)phosphinate, nickel dibutylphosphinate, nickel dipentylphosphinate, nickel dihexylphosphinate, nickel diheptylphosphinate, nickel dioctylphosphinate, nickel bis(1-methylheptyl)phosphinate, nickel bis(2-ethylhexyl)phosphinate, nickel didecylphosphinate, nickel didodecylphosphinate, nickel dioctadecylphosphinate, nickel dioleylphosphinate, nickel diphenylphosphinate, nickel bis(p-nonylphenyl)phosphinate, nickel butyl(2-ethylhexyl)phosphinate, nickel (1-methylheptyl)(2-ethylhexyl)phosphinate, and nickel (2-ethylhexyl) (p-nonylphenyl) phosphinate.

Nickel carbamates can include nickel dimethylcarbamate, nickel diethylcarbamate, nickel diisopropylcarbamate, nickel dibutylcarbamate, and nickel dibenzylcarbamate.

Nickel dithiocarbamates can include nickel dimethyldithiocarbamate, nickel diethyldithiocarbamate, nickel diisopropyldithiocarbamate, nickel dibutyldithiocarbamate, and nickel dibenzyldithiocarbamate.

Nickel xanthates include nickel methylxanthate, nickel ethylxanthate, nickel isopropylxanthate, nickel butylxanthate, and nickel benzylxanthate.

Nickel β-diketonates can include nickel acetylacetonate, nickel trifluoroacetylacetonate, nickel hexafluoroacetylacetonate, nickel benzoylacetonate, and nickel 2,2,6,6-tetramethyl-3,5-heptanedionate.

Nickel alkoxides or aryloxides can include nickel methoxide, nickel ethoxide, nickel isopropoxide, nickel 2-ethylhexoxide, nickel phenoxide, nickel nonylphenoxide, and nickel naphthoxide.

Nickel halides can include nickel fluoride, nickel chloride, nickel bromide, and nickel iodide. Nickel pseudo-halides include nickel cyanide, nickel cyanate, nickel thiocyanate, nickel azide, and nickel ferrocyanide. Nickel oxyhalides include nickel oxyfluoride, nickel oxychloride and nickel oxybromide. Where the nickel halides, nickel oxyhalides or other nickel-containing compounds contain labile fluorine or chlorine atoms, the nickel-containing compounds can also serve as the fluorine-containing compound or the chlorine-containing compound. A Lewis base such as an alcohol can be used as a solubility aid for this class of compounds.

The term organonickel compound may refer to any nickel compound containing at least one nickel-carbon bond. Organonickel compounds include bis(cyclopentadienyl) nickel (also called nickelocene), bis(pentamethylcyclopentadienyl) nickel (also called decamethylnickelocene), bis(tetramethylcyclopentadienyl) nickel, bis(ethylcyclopentadienyl) nickel, bis(isopropylcyclopentadienyl) nickel, bis(pentadienyl) nickel, bis(2,4-dimethylpentadienyl) nickel, (cyclopentadienyl)(pentadienyl)nickel, bis(1,5-cyclooctadiene)nickel, bis(allyl)nickel, bis(methallyDnickel, and bis(crotyl)nickel.

### Alkylating Agent Blend

As mentioned above, the lanthanide-based catalyst systems and the nickel-based catalyst systems include an aluminum hydride compound in addition to triethylaluminum. The aluminum hydride and triethylaluminum may be referred to in combination as the alkylating agent blend or alkylating agent system.

As the skilled person will appreciate, triethylaluminum can be defined by the formula Al(CH₂CH₃)₃.

The aluminum hydride compounds, which may also be referred to as hydrocarbyl aluminum hydrides, can be represented by the general formula A1RₙH₃₋ₙ, where each R independently can be a monovalent organic group that is attached to the aluminum atom via a carbon atom, and where n can be an integer in the range of from 1 to 3. In one or more embodiments, each R independently can be a hydrocarbyl group such as, for example, alkyl, cycloalkyl, substituted cycloalkyl, alkenyl, cycloalkenyl, substituted cycloalkenyl, aryl, substituted aryl, aralkyl, alkaryl, allyl, and alkynyl groups, with each group containing in the range of from 1 carbon atom, or the appropriate minimum number of carbon atoms to form the group, up to about 20 carbon atoms. These hydrocarbyl groups may contain heteroatoms including, but not limited to, nitrogen, oxygen, boron, silicon, sulfur, and phosphorus atoms. In one or more embodiments, the aluminum hydride may be a dihydrocarbylaluminum hydride and in other embodiments it may be a hydrocarbylaluminum dihydride.

Suitable dihydrocarbylaluminum hydride compounds include, but are not limited to, diethylaluminum hydride, di-n-propylaluminum hydride, diisopropylaluminum hydride, di-n-butylaluminum hydride, diisobutylaluminum hydride, di-n-octylaluminum hydride, diphenylaluminum hydride, di-p-tolylaluminum hydride, dibenzylaluminum hydride, phenylethylaluminum hydride, phenyl-n-propylaluminum hydride, phenylisopropylaluminum hydride, phenyl-n-butylaluminum hydride, phenylisobutylaluminum hydride, phenyl-n-octylaluminum hydride, p-tolylethylaluminum hydride, p-tolyl-n-propylaluminum hydride, p-tolylisopropylaluminum hydride, p-tolyl-n-butylaluminum hydride, p-tolylisobutylaluminum hydride, p-tolyl-n-octylaluminum hydride, benzylethylaluminum hydride, benzyl-n-propylaluminum hydride, benzylisopropylaluminum hydride, benzyl-n-butylaluminum hydride, benzylisobutylaluminum hydride, and benzyl-n-octylaluminum hydride.

Suitable hydrocarbylaluminum dihydrides include, but are not limited to, ethylaluminum dihydride, n-propylaluminum dihydride, isopropylaluminum dihydride, n-butylaluminum dihydride, isobutylaluminum dihydride, and n-octylaluminum dihydride.

### Halogen-Containing Compounds

As mentioned above, the lanthanide-based catalyst systems and the nickel-based catalyst systems include a halogen-containing compound.

Various compounds, or mixtures thereof, that contain one or more halogen atoms can be employed as the halogen-containing compound. Examples of halogen atoms include, but are not limited to, fluorine, chlorine, bromine, and iodine. A combination of two or more halogen atoms can also be utilized. Halogen-containing compounds that are soluble in a hydrocarbon solvent are suitable for use in the present invention. Hydrocarbon-insoluble halogen-containing compounds, however, can be suspended in a polymerization system to form the catalytically active species, and are therefore also useful.

Useful types of halogen-containing compounds that can be employed include, but are not limited to, elemental halogens, mixed halogens, hydrogen halides, organic halides, inorganic halides, metallic halides, and organometallic halides.

Suitable elemental halogens include, but are not limited to, fluorine, chlorine, bromine, and iodine. Some specific examples of suitable mixed halogens include iodine monochloride, iodine monobromide, iodine trichloride, and iodine pentafluoride.

Suitable hydrogen halides include, but are not limited to, hydrogen fluoride, hydrogen chloride, hydrogen bromide, and hydrogen iodide.

Suitable organic halides include, but are not limited to, t-butyl chloride, t-butyl bromide, allyl chloride, allyl bromide, benzyl chloride, benzyl bromide, chloro-di-phenylmethane, bromo-di-phenylmethane, triphenylmethyl chloride, triphenylmethyl bromide, benzylidene chloride, benzylidene bromide, methyltrichlorosilane, phenyltrichlorosilane, dimethyldichlorosilane, diphenyldichlorosilane, trimethylchlorosilane, benzoyl chloride, benzoyl bromide, propionyl chloride, propionyl bromide, methyl chloroformate, and methyl bromoformate.

Suitable inorganic halides include, but are not limited to, phosphorus trichloride, phosphorus tribromide, phosphorus pentachloride, phosphorus oxychloride, phosphorus oxybromide, boron trifluoride, boron trichloride, boron tribromide, silicon tetrafluoride, silicon tetrachloride, silicon tetrabromide, silicon tetraiodide, arsenic trichloride, arsenic tribromide, arsenic triiodide, selenium tetrachloride, selenium tetrabromide, tellurium tetrachloride, tellurium tetrabromide, and tellurium tetraiodide.

Suitable metallic halides include, but are not limited to, tin tetrachloride, tin tetrabromide, aluminum trichloride, aluminum tribromide, antimony trichloride, antimony pentachloride, antimony tribromide, aluminum triiodide, aluminum trifluoride, gallium trichloride, gallium tribromide, gallium triiodide, gallium trifluoride, indium trichloride, indium tribromide, indium triiodide, indium trifluoride, titanium tetrachloride, titanium tetrabromide, titanium tetraiodide, zinc dichloride, zinc dibromide, zinc diiodide, and zinc difluoride.

Suitable organometallic halides include, but are not limited to, dimethylaluminum chloride, diethylaluminum chloride, dimethylaluminum bromide, diethylaluminum bromide, dimethylaluminum fluoride, diethylaluminum fluoride, methylaluminum dichloride, ethylaluminum dichloride, methylaluminum dibromide, ethylaluminum dibromide, methylaluminum difluoride, ethylaluminum difluoride, methylaluminum sesquichloride, ethylaluminum sesquichloride, isobutylaluminum sesquichloride, methylmagnesium chloride, methylmagnesium bromide, methylmagnesium iodide, ethylmagnesium chloride, ethylmagnesium bromide, butylmagnesium chloride, butylmagnesium bromide, phenylmagnesium chloride, phenylmagnesium bromide, benzylmagnesium chloride, trimethyltin chloride, trimethyltin bromide, triethyltin chloride, triethyltin bromide, di-t-butyltin dichloride, di-t-butyltin dibromide, dibutyltin dichloride, dibutyltin dibromide, tributyltin chloride, and tributyltin bromide.

In one or more embodiments, the lanthanide-based catalyst systems can comprise a compound containing a non-coordinating anion or a non-coordinating anion precursor. In one or more embodiments, a compound containing a non-coordinating anion, or a non-coordinating anion precursor can be employed in lieu of the above-described halogen source. A non-coordinating anion is a sterically bulky anion that does not form coordinate bonds with, for example, the active center of a catalyst system due to steric hindrance. Non-coordinating anions useful in the present invention include, but are not limited to, tetraarylborate anions and fluorinated tetraarylborate anions. Compounds containing a non-coordinating anion can also contain a counter cation, such as a carbonium, ammonium, or phosphonium cation. Exemplary counter cations include, but are not limited to, triarylcarbonium cations and N,N-dialkylanilinium cations. Examples of compounds containing a non-coordinating anion and a counter cation include, but are not limited to, triphenylcarbonium tetrakis(pentafluorophenyl)borate, N,N-dimethylanilinium tetrakis(pentafluorophenyl)borate, triphenylcarbonium tetrakis [3,5-bis(trifluoromethyl)phenyl]borate, and N,N-dimethylanilinium tetrakis [3,5-bis(trifluoromethyl) phenyl]borate.

The skilled person will appreciate that the halogen-containing compound may include the lanthanide-containing compound or the nickel-containing compound where those compounds include a labile halogen atom.

A non-coordinating anion precursor can also be used in this embodiment. A non-coordinating anion precursor is a compound that is able to form a non-coordinating anion under reaction conditions. Useful non-coordinating anion precursors include, but are not limited to, triarylboron compounds, BR₃, where R is a strong electron-withdrawing aryl group, such as a pentafluorophenyl or 3,5-bis(trifluoromethyl)phenyl group.

### Fluorine-Containing Compound

In particular embodiments, the nickel-based catalyst systems may include a fluorine-containing compound. Fluorine-containing compounds may include various compounds, or mixtures thereof, that contain one or more labile fluorine atoms. In one or more embodiments, the fluorine-containing compound may be soluble in a hydrocarbon solvent. In other embodiments, hydrocarbon-insoluble fluorine-containing compounds, which can be suspended in the polymerization medium to form the catalytically active species, may be useful.

Types of fluorine-containing compounds include, but are not limited to, elemental fluorine, halogen fluorides, hydrogen fluoride, organic fluorides, inorganic fluorides, metallic fluorides, organometallic fluorides, and mixtures thereof. In one or more embodiments, the complexes of the fluorine-containing compounds with a Lewis base such as ethers, alcohols, water, aldehydes, ketones, esters, nitriles, or mixtures thereof may be employed. Specific examples of these complexes include the complexes of boron trifluoride and hydrogen fluoride with a Lewis base.

Halogen fluorides may include iodine monofluoride, iodine trifluoride, and iodine pentafluoride.

Organic fluorides may include t-butyl fluoride, allyl fluoride, benzyl fluoride, fluoro-di-phenylmethane, triphenylmethyl fluoride, benzylidene fluoride, methyltrifluorosilane, phenyltrifluorosilane, dimethyldifluorosilane, diphenyldifluorosilane, trimethylfluorosilane, benzoyl fluoride, propionyl fluoride, and methyl fluoroformate.

Inorganic fluorides may include phosphorus trifluoride, phosphorus pentafluoride, phosphorus oxyfluoride, boron trifluoride, silicon tetrafluoride, arsenic trifluoride, selenium tetrafluoride, and tellurium tetrafluoride.

Metallic fluorides may include tin tetrafluoride, aluminum trifluoride, antimony trifluoride, antimony pentafluoride, gallium trifluoride, indium trifluoride, titanium tetrafluoride, and zinc difluoride.

Organometallic fluorides may include dimethylaluminum fluoride, diethylaluminum fluoride, methylaluminum difluoride, ethylaluminum difluoride, methylaluminum sesquifluoride, ethylaluminum sesquifluoride, isobutylaluminum sesquifluoride, methylmagnesium fluoride, ethylmagnesium fluoride, butylmagnesium fluoride, phenylmagnesium fluoride, benzylmagnesium fluoride, trimethyltin fluoride, triethyltin fluoride, di-t-butyltin difluoride, dibutyltin difluoride, and tributyltin fluoride.

Various compounds, or mixtures thereof, that contain one or more labile chlorine atoms can be employed as the chlorine-containing compound. In one or more embodiments, the chlorine-containing compound may be soluble in a hydrocarbon solvent. In other embodiments, hydrocarbon-insoluble chlorine-containing compounds, which can be suspended in the polymerization medium to form the catalytically active species, may be useful.

### Catalyst Component Ratios

In the first set of embodiments, the lanthanide-based catalyst composition used in this invention may be formed by combining or mixing the foregoing catalyst ingredients. Although one or more active catalyst species are believed to result from the combination of the lanthanide-based catalyst ingredients, the degree of interaction or reaction between the various catalyst ingredients or components is not known with any great degree of certainty. Therefore, the term “catalyst composition” has been employed to encompass a simple mixture of the ingredients, a complex of the various ingredients that is caused by physical or chemical forces of attraction, a chemical reaction product of the ingredients, or a combination of the foregoing.

In one or more embodiments, the molar ratio of the triethylaluminum hydride to the lanthanide-containing compound (alkylating agent/Ln) can be varied from about 2:1 to about 15:1, in other embodiments from about 3.5:1 to about 10:1, and in other embodiments from about 4.5:1 to about 7.5:1.

In one or more embodiments, the molar ratio of the hydrocarbylaluminum hydride to the lanthanide-containing compound (alkylating agent/Ln) can be varied from about 1:1 to about 10:1, in other embodiments from about 2.5:1 to about 8:1, and in other embodiments from about 4:1 to about 6:1.

In one or more embodiments, the molar ratio of the halogen-containing compound to the lanthanide-containing compound is best described in terms of the ratio of the moles of halogen atoms in the halogen source to the moles of lanthanide atoms in the lanthanide-containing compound (halogen/Ln). In one or more embodiments, the halogen/Ln molar ratio can be varied from about 0.5:1 to about 20:1, in other embodiments from about 1:1 to about 10:1, and in other embodiments from about 2:1 to about 6:1.

In yet another embodiment, the molar ratio of the non-coordinating anion or non-coordinating anion precursor to the lanthanide-containing compound (An/Ln) may be from about 0.5:1 to about 20:1, in other embodiments from about 0.75:1 to about 10:1, and in other embodiments from about 1:1 to about 6:1.

In the second set of embodiments, the nickel-based catalyst composition used in this invention may be formed by combining or mixing the foregoing catalyst ingredients. Although one or more active catalyst species are believed to result from the combination of the nickel-based catalyst ingredients, the degree of interaction or reaction between the various catalyst ingredients or components is not known with any great degree of certainty. Therefore, the term “catalyst composition” has been employed to encompass a simple mixture of the ingredients, a complex of the various ingredients that is caused by physical or chemical forces of attraction, a chemical reaction product of the ingredients, or a combination of the foregoing.

In one or more embodiments, the molar ratio of the triethylaluminum to the nickel-containing compound (alkylating agent/Ni) can be varied from about 1:1 to about 200:1, in other embodiments from about 2:1 to about 100:1, and in other embodiments from about 5:1 to about 50:1.

In one or more embodiments, the molar ratio of the hydrocarbylaluminum hydride to the nickel-containing compound (alkylating agent/Ni) can be varied from about 1:1 to about 500:1, in other embodiments from about 2:1 to about 100:1, and in other embodiments from about 3:1 to about 50:1.

In those embodiments where the nickel-containing catalyst system includes a fluorine-containing compound, the molar ratio of the fluorine-containing compound to the nickel-containing compound is best described in terms of the ratio of the moles of fluorine atoms in the fluorine-containing compound to the moles of nickel atoms in the nickel-containing compound (F/Ni). In one or more embodiments, the F/Ni molar ratio can be varied from about 2:1 to about 500:1, in other embodiments from about 5:1 to about 300:1, and in other embodiments from about 8:1 to about 200:1.

### Catalyst Formation

Various procedures can be used to prepare lanthanide-based and nickel-based catalyst systems of this invention. In one or more embodiments, the catalyst systems may be formed in situ by separately adding the catalyst components to the monomer to be polymerized in either a stepwise or simultaneous manner. In other embodiments, the catalyst system may be preformed. That is, the catalyst components are pre-mixed outside the polymerization system either in the absence of any monomer or in the presence of a small amount of monomer. The resulting preformed catalyst composition may be aged, if desired, and then added to the monomer that is to be polymerized.

The catalyst systems can be formed by various methods.

In one embodiment, the catalyst composition may be formed in situ by adding the catalyst ingredients to a solution containing monomer and solvent, or to bulk monomer, in either a stepwise or simultaneous manner. In one embodiment, the alkylating agent can be added first, followed by the lanthanide-containing or nickel-containing compound, and then followed by the halogen-containing compound or by the compound containing a non-coordinating anion or the non-coordinating anion precursor.

In another embodiment, the catalyst composition may be preformed. That is, the catalyst ingredients are pre-mixed outside the polymerization system either in the absence of any monomer or in the presence of a small amount of at least one conjugated diene monomer at an appropriate temperature, which may be from about −20° C. to about 80° C. The amount of conjugated diene monomer that may be used for preforming the catalyst can range from about 1 to about 500 moles, in other embodiments from about 5 to about 250 moles, and in other embodiments from about 10 to about 100 moles per mole of the lanthanide-containing or nickel-containing compound. The resulting catalyst composition may be aged, if desired, prior to being added to the monomer that is to be polymerized.

In yet another embodiment, the catalyst composition may be formed by using a two-stage procedure. The first stage may involve combining the alkylating agent with the lanthanide-containing or nickel-containing compound either in the absence of any monomer or in the presence of a small amount of at least one conjugated diene monomer at an appropriate temperature, which may be from about −20° C. to about 80° C. The amount of monomer employed in the first stage may be similar to that set forth above for preforming the catalyst. In the second stage, the mixture formed in the first stage and the halogen-containing compound, non-coordinating anion, or non-coordinating anion precursor can be charged in either a stepwise or simultaneous manner to the monomer that is to be polymerized.

In one or more embodiments, a solvent may be employed as a carrier to either dissolve or suspend the catalyst or initiator in order to facilitate the delivery of the catalyst to the polymerization system. In other embodiments, monomer can be used as the carrier. In yet other embodiments, the catalyst can be used in their neat state without any solvent.

In one or more embodiments, suitable solvents include those organic compounds that will not undergo polymerization or incorporation into propagating polymer chains during the polymerization of monomer in the presence of the catalyst or initiator. In one or more embodiments, these organic species are liquid at ambient temperature and pressure. In one or more embodiments, these organic solvents are inert to the catalyst or initiator. Exemplary organic solvents include hydrocarbons with a low or relatively low boiling point such as aromatic hydrocarbons, aliphatic hydrocarbons, and cycloaliphatic hydrocarbons. Non-limiting examples of aromatic hydrocarbons include benzene, toluene, xylenes, ethylbenzene, diethylbenzene, and mesitylene. Non-limiting examples of aliphatic hydrocarbons include n-pentane, n-hexane, n-heptane, n-octane, n-nonane, n-decane, isopentane, isohexanes, isopentanes, isooctanes, 2,2-dimethylbutane, petroleum ether, kerosene, and petroleum spirits. And, non-limiting examples of cycloaliphatic hydrocarbons include cyclopentane, cyclohexane, methylcyclopentane, and methylcyclohexane. Mixtures of the above hydrocarbons may also be used. As is known in the art, aliphatic and cycloaliphatic hydrocarbons may be desirably employed for environmental reasons. The low-boiling hydrocarbon solvents are typically separated from the polymer upon completion of the polymerization.

Other examples of organic solvents include high-boiling hydrocarbons of high molecular weights, including hydrocarbon oils that are commonly used to oil-extend polymers. Examples of these oils include paraffinic oils, aromatic oils, naphthenic oils, vegetable oils other than castor oils, and low PCA oils including MES, TDAE, SRAE, heavy naphthenic oils. Since these hydrocarbons are non-volatile, they typically do not require separation and remain incorporated in the polymer.

### Polymerization Process

The foregoing lanthanide-based catalyst composition or nickel-based catalyst composition has relatively high catalytic activity for polymerizing conjugated dienes into polymer over a wide range of catalyst concentrations and catalyst ingredient ratios. The polymer may be referred to as a polydiene, and in one or more embodiments may include cis-1,4-polydienes. Several factors may impact the optimum concentration of any one of the catalyst ingredients. For example, because the catalyst ingredients may interact to form an active species, the optimum concentration for any one catalyst ingredient may be dependent upon the concentrations of the other catalyst ingredients.

Examples of conjugated diene monomer include 1,3-butadiene, isoprene, 1,3-pentadiene, 1,3-hexadiene, 2,3-dimethyl-1,3-butadiene, 2-ethyl-1,3-butadiene, 2-methyl-1,3-pentadiene, 3-methyl-1,3-pentadiene, 4-methyl-1,3-pentadiene, and 2,4-hexadiene.

The production of the reactive polymer according to this invention can be accomplished by polymerizing conjugated diene monomer, optionally together with monomer copolymerizable with conjugated diene monomer, in the presence of a catalytically effective amount of the catalyst. The introduction of the catalyst, the conjugated diene monomer, optionally the comonomer, and any solvent, if employed, forms a polymerization mixture in which the reactive polymer is formed. The amount of the catalyst or initiator to be employed may depend on the interplay of various factors such as the type of catalyst or initiator employed, the purity of the ingredients, the polymerization temperature, the polymerization rate and conversion desired, the molecular weight desired, and many other factors. Accordingly, a specific catalyst or initiator amount cannot be definitively set forth except to say that catalytically effective amounts of the catalyst or initiator may be used.

In one or more embodiments, the amount of the coordinating metal compound (e.g., a lanthanide-containing compound or nickel-containing compound) used can be varied from about 0.001 to about 2 mmol, in other embodiments from about 0.005 to about 1 mmol, and in still other embodiments from about 0.01 to about 0.2 mmol per 100 gram of monomer.

In one or more embodiments, the polymerization may be carried out in a polymerization system that includes a substantial amount of solvent. In one embodiment, a solution polymerization system may be employed in which both the monomer to be polymerized and the polymer formed are soluble in the solvent. In another embodiment, a precipitation polymerization system may be employed by choosing a solvent in which the polymer formed is insoluble. In both cases, an amount of solvent in addition to the amount of solvent that may be used in preparing the catalyst is usually added to the polymerization system. The additional solvent may be the same as or different from the solvent used in preparing the catalyst. Exemplary solvents have been set forth above. In one or more embodiments, the solvent content of the polymerization mixture may be more than 20% by weight, in other embodiments more than 50% by weight, and in still other embodiments more than 80% by weight based on the total weight of the polymerization mixture.

In other embodiments, the polymerization system employed may be generally considered a bulk polymerization system that includes substantially no solvent or a minimal amount of solvent. Those skilled in the art will appreciate the benefits of bulk polymerization processes (i.e. processes where monomer acts as the solvent), and therefore the polymerization system includes less solvent than will deleteriously impact the benefits sought by conducting bulk polymerization. In one or more embodiments, the solvent content of the polymerization mixture may be less than about 20% by weight, in other embodiments less than about 10% by weight, and in still other embodiments less than about 5% by weight based on the total weight of the polymerization mixture. In another embodiment, the polymerization mixture contains no solvents other than those that are inherent to the raw materials employed. In still another embodiment, the polymerization mixture is substantially devoid of solvent, which refers to the absence of that amount of solvent that would otherwise have an appreciable impact on the polymerization process. Polymerization systems that are substantially devoid of solvent may be referred to as including substantially no solvent. In particular embodiments, the polymerization mixture is devoid of solvent.

The polymerization may be conducted in any conventional polymerization vessels known in the art. In one or more embodiments, solution polymerization can be conducted in a conventional stirred-tank reactor. In other embodiments, bulk polymerization can be conducted in a conventional stirred-tank reactor, especially if the monomer conversion is less than about 60%. In still other embodiments, especially where the monomer conversion in a bulk polymerization process is higher than about 60%, which typically results in a highly viscous cement, the bulk polymerization may be conducted in an elongated reactor in which the viscous cement under polymerization is driven to move by piston, or substantially by piston. For example, extruders in which the cement is pushed along by a self-cleaning single-screw or double-screw agitator are suitable for this purpose. Examples of useful bulk polymerization processes are disclosed in U.S. Pat. No. 7,351,776, which is incorporated herein by reference.

In one or more embodiments, all of the ingredients used for the polymerization can be combined within a single vessel (e.g., a conventional stirred-tank reactor), and all steps of the polymerization process can be conducted within this vessel. In other embodiments, two or more of the ingredients can be pre-combined in one vessel and then transferred to another vessel where the polymerization of monomer (or at least a major portion thereof) may be conducted.

The polymerization can be carried out as a batch process, a continuous process, or a semi-continuous process. In the semi-continuous process, the monomer is intermittently charged as needed to replace that monomer already polymerized. In one or more embodiments, the conditions under which the polymerization proceeds may be controlled to maintain the temperature of the polymerization mixture within a range from about −10° C. to about 200° C., in other embodiments from about 0° C. to about 150° C., and in other embodiments from about 20° C. to about 100° C. In one or more embodiments, the heat of polymerization may be removed by external cooling by a thermally controlled reactor jacket, internal cooling by evaporation and condensation of the monomer through the use of a reflux condenser connected to the reactor, or a combination of the two methods. Also, the polymerization conditions may be controlled to conduct the polymerization under a pressure of from about 0.1 atmosphere to about 50 atmospheres, in other embodiments from about 0.5 atmosphere to about 20 atmosphere, and in other embodiments from about 1 atmosphere to about 10 atmospheres. In one or more embodiments, the pressures at which the polymerization may be carried out include those that ensure that the majority of the monomer is in the liquid phase. In these or other embodiments, the polymerization mixture may be maintained under anaerobic conditions.

As indicated above, the catalyst system and polymerization process of the present invention results in advantageous polymerization activity. In one or more embodiments, the polymerization activity can be expressed in terms of monomer conversion of the polymerization process. In one or more embodiments, the catalyst system and polymerization process achieve a monomer conversion of greater than 80%, in other embodiments greater than 85%, and in other embodiments greater than 90%. REACTIVE POLYMER

In one or more embodiments, the polymerization process of the present invention produces a reactive polymer. This reactive polymer is believed to be prepared by coordination polymerization mechanism. The key mechanistic features of coordination polymerization have been discussed in books (e.g., Kuran, W., Principles of Coordination Polymerization; John Wiley & Sons: New York, 2001) and review articles (e.g., Mulhaupt, R., Macromolecular Chemistry and Physics 2003, volume 204, pages 289-327). Coordination catalysts are believed to initiate the polymerization of monomer by a mechanism that involves the coordination or complexation of monomer to an active metal center prior to the insertion of monomer into a growing polymer chain. An advantageous feature of coordination catalysts is their ability to provide stereochemical control of polymerizations and thereby produce stereoregular polymers. As is known in the art, there are numerous methods for creating coordination catalysts, but all methods eventually generate an active intermediate that is capable of coordinating with monomer and inserting monomer into a covalent bond between an active metal center and a growing polymer chain. The coordination polymerization of conjugated dienes is believed to proceed via 7r-allyl complexes as intermediates. Coordination catalysts can be one-, two-, three- or multi-component systems. In one or more embodiments, a coordination catalyst may be formed by combining a heavy metal compound (e.g., a lanthanide-containing compound), an alkylating agent (e.g., an organoaluminum compound), and optionally other co-catalyst components (e.g., a Lewis acid or a Lewis base). In one or more embodiments, the heavy metal compound may be referred to as a coordinating metal compound.

In one or more embodiments, especially where the lanthanide-based catalyst system is employed, the resulting polymer chains possess reactive chain ends before the polymerization mixture is quenched. Thus, reference to a reactive polymer refers to a polymer having a reactive chain end deriving from a synthesis of the polymer by using a coordination catalyst, which reactive polymer may be referred to as a pseudo-living polymer. In one or more embodiments, a polymerization mixture including reactive polymer may be referred to as an active polymerization mixture. The percentage of polymer chains possessing a reactive end depends on various factors such as the type of catalyst or initiator, the type of monomer, the purity of the ingredients, the polymerization temperature, the monomer conversion, and many other factors. In one or more embodiments, at least about 5% of the polymer chains possess a reactive end, in other embodiments at least about 10% of the polymer chains possess a reactive end, and in still other embodiments at least about 15% of the polymer chains possess a reactive end. In any event, the reactive polymer can be reacted with a functionalizing agent to form the coupled polymer of this invention.

### Functionalization

In one or more embodiments, a functionalizing agent may optionally be added to the polymerization mixture to functionalize at least some of the polymer chains, especially those with a reactive chain end. A mixture of two or more functionalizing agents may also be employed.

In one or more embodiments, functionalizing agents include compounds or reagents that can react with a reactive polymer produced by this invention and thereby provide the polymer with a functional group that is distinct from a propagating chain that has not been reacted with the functionalizing agent. The functional group may be reactive or interactive with other polymer chains (propagating and/or non-propagating) or with other constituents such as reinforcing fillers (e.g. carbon black) that may be combined with the polymer. In one or more embodiments, the reaction between the functionalizing agent and the reactive polymer proceeds via an addition or substitution reaction.

Useful functionalizing agents may include compounds that simply provide a functional group at the end of a polymer chain. In one or more embodiments, functionalizing agents include compounds that will add or impart a heteroatom to the polymer chain. In particular embodiments, functionalizing agents include those compounds that will impart a functional group to the polymer chain to form a functionalized polymer that reduces the 50° C. hysteresis loss of a carbon-black filled vulcanizates prepared from the functionalized polymer as compared to similar carbon-black filled vulcanizates prepared from non-functionalized polymer.

In other embodiments, an additional coupling agent may be used in combination with the functionalizing agent. These compounds, which may be referred to as co-coupling agents, may join two or more polymer chains together to form a single macromolecule. Because certain functionalizing agents may serve to couple polymer chains in addition to providing the polymer chain with a useful functionality, the co-coupling agents may simply be referred to as functionalizing agents herein.

In one or more embodiments, suitable functionalizing agents include those compounds that contain groups that may react with the reactive polymers produced in accordance with this invention. Exemplary functionalizing agents include ketones, quinones, aldehydes, amides, esters, isocyanates, isothiocyanates, epoxides, imines, aminoketones, aminothioketones, and acid anhydrides. Examples of these compounds are disclosed in U.S. Pat. Nos. 4,906,706, 4,990,573, 5,064,910, 5,567,784, 5,844,050, 6,838,526, 6,977,281, and 6,992,147; U.S. Publication Nos. 2006/0004131 A1, 2006/0025539 A1, 2006/0030677 A1, and 2004/0147694 A1; Japanese Patent Application Nos. 05-051406A, 05-059103A, 10-306113A, and 11-035633A; which are incorporated herein by reference. Other examples of functionalizing agents include azine compounds as described in U.S. Ser. No. 11/640,711, hydrobenzamide compounds as disclosed in U.S. Ser. No. 11/710,713, nitro compounds as disclosed in U.S. Ser. No. 11/710,845, and protected oxime compounds as disclosed in U.S. Ser. No. 60/875,484, all of which are incorporated herein by reference.

In particular embodiments, the functionalizing agents employed may be epoxides, isocyanates, metal carboxylates, hydrocarbylmetal carboxylates, and hydrocarbylmetal ester-carboxylates.

In one or more embodiments, exemplary epoxide compounds may be selected from (3-glycidyloxypropyl)trimethoxysilane, (3-glycidyloxypropyl)triethoxysilane, (3-glycidyloxypropyl)triphenoxysilane, (3-glycidyloxypropyl)methyldimethoxysilane, (3-glycidyloxypropyl)methyldiethoxysilane, (3-glycidyloxypropyl) methyldiphenoxysilane, [2-(3,4-epoxycyclohexyl) ethyl]trimethoxysilane, and [2-(3,4-epoxycyclohexyl) ethyl]triethoxysilane.

Exemplary isocyanate compounds include (3-isocyanatopropyl) trimethoxysilane, (3-isocyanatopropyl) triethoxysilane, (3-isocyanatopropyl) triphenoxysilane, (3-isocyanatopropyl) methyldimethoxysilane, (3-isocyanatopropyl) methyldiethoxysilane (3-isocyanatopropyl) methyldiphenoxysilane, and (isocyanatomethyl)methyldimethoxysilane.

Exemplary metal carboxylate compounds include tin tetraacetate, tin bis(2-ethylhexanaote), and tin bis(neodecanoate).

Exemplary hydrocarbylmetal carboxylate compounds include triphenyltin 2-ethylhexanoate, tri-n-butyltin 2-ethylhexanoate, tri-n-butyltin neodecanoate, triisobutyltin 2-ethylhexanoate, diphenyltin bis(2-ethylhexanoate), di-n-butyltin bis(2-ethylhexanoate), di-n-butyltin bis(neodecanoate), phenyltin tris(2-ethylhexanoate), and n-butyltin tris(2-ethylhexanoate).

Exemplary hydrocarbylmetal ester-carboxylate compounds include di-n-butyltin bis(n-octylmaleate), di-n-octyltin bis(n-octylmaleate), diphenyltin bis(n-octylmaleate), di-n-butyltin bis(2-ethylhexylmaleate), di-n-octyltin bis(2-ethylhexylmaleate), and diphenyltin bis(2-ethylhexylmaleate).

Exemplary metal alkoxide compounds include dimethoxytin, diethoxytin, tetraethoxytin, tetra-n-propoxytin, tetraisopropoxytin, tetra-n-butoxytin, tetraisobutoxytin, tetra-t-butoxytin, and tetraphenoxytin.

The amount of the functionalizing agent that can be added to the polymerization mixture may depend on various factors including the type and amount of catalyst or initiator used to synthesize the reactive polymer and the desired degree of functionalization. In one or more embodiments, the amount of the functionalizing agent employed can be described with reference to the lanthanide metal of the lanthanide-containing compound. For example, the molar ratio of the functionalizing agent to the lanthanide metal may be from about 1:1 to about 200:1, in other embodiments from about 5:1 to about 150:1, and in other embodiments from about 10:1 to about 100:1.

### Post-Polymerization Work Up

In one or more embodiments, after polymerization, and optionally after functionalization of the reactive polymer, a quenching agent can be added to the polymerization mixture in order to protonate the reaction product between the reactive polymer and the functionalizing agent, inactivate any residual reactive polymer chains, and/or inactivate the catalyst or catalyst components. The quenching agent may include a protic compound, which includes, but is not limited to, an alcohol, a carboxylic acid, an inorganic acid, water, or a mixture thereof. An antioxidant such as 2,6-di-tert-butyl-4-methylphenol may be added along with, before, or after the addition of the quenching agent. The amount of the antioxidant employed may be in the range of 0.01% to 1% by weight of the polymer product. Additionally, the polymer product can be oil extended by adding an oil to the polymer, which may be in the form of a polymer cement or polymer dissolved or suspended in monomer. Practice of the present invention does not limit the amount of oil that may be added, and therefore conventional amounts may be added (e.g., 5-50 phr). Useful oils or extenders that may be employed include, but are not limited to, aromatic oils, paraffinic oils, naphthenic oils, vegetable oils other than castor oils, low PCA oils including MES, TDAE, and SRAE, and heavy naphthenic oils.

Once the polymerization mixture has been quenched, the various constituents of the polymerization mixture may be recovered. In one or more embodiments, the unreacted monomer can be recovered from the polymerization mixture. For example, the monomer can be distilled from the polymerization mixture by using techniques known in the art. Once the monomer has been removed from the polymerization mixture, the monomer may be purified, stored, and/or recycled back to the polymerization process.

The polymer product may be recovered from the polymerization mixture by using techniques known in the art. In one or more embodiments, desolventization and drying techniques may be used. The polymer can be recovered by subjecting the polymerization mixture to steam desolventization, followed by drying the resulting polymer crumbs in a hot air tunnel. Alternatively, the polymer can be recovered by passing it through an expander-expeller. The polymer can also be recovered by directly drying the polymerization mixture on a drum dryer.

### Polymer Properties

In one or more embodiments, the polymers prepared according to this invention may contain unsaturation. In these or other embodiments, the coupled polymers are vulcanizable. In one or more embodiments, the coupled polymers can have a glass transition temperature (T_{g}) that is less than 0° C., in other embodiments less than −40° C., and in other embodiments less than −60° C.

In one or more embodiments, the coupled polymers of this invention may be cis-1,4-polydienes having a cis-1,4-linkage content that is greater than 85%, in other embodiments greater than about 90%, in other embodiments greater than about 92%, and in other embodiments greater than about 94%, where the percentages are based upon the number of diene mer units adopting the cis-1,4 linkage versus the total number of diene mer units. The cis-1,4-, 1,2-, and trans-1,4-linkage contents can be determined by infrared spectroscopy.

In one or more embodiments, the number average molecular weight (Mₙ) of these polymers produced according to this invention may be from about 10 to about 1,000, in other embodiments from about 50 to about 500, in other embodiments from about 100 to about 400, and in other embodiments from about 200 to about 300 kg/mol, as determined by using gel permeation chromatography (GPC) calibrated with polystyrene standards. In these or other embodiments, the molecular weight distribution or polydispersity (M_{w}/Mₙ) of these polymers may be from about 1.0 to about 7.0, in other embodiments from about 1.5 to about 5.0, and in other embodiments from about 2.0 to about 4.0. In these or other embodiments, the molecular weight distribution or polydispersity (M_{w}/Mₙ) of these polymers may be less than 7.0, in other embodiments less than 5.0, in other embodiments less than 4.0, and in other embodiments less than 3.0.

Where the polymer is functionalized, the reactive polymer and the functionalizing agent (and optionally the functionalizing agent) are believed to react to produce a functionalized or coupled polymer, wherein the residue of the functionalizing agent is imparted to the end of at least one polymer chain. It is believed that the reactive end of the polymer chain reacts with the functionalizing agent and in certain embodiments up to three chain ends react with the functionalizing agent to form a coupled polymer. Nonetheless, the exact chemical structure of the coupled polymer produced in every embodiment is not known with any great degree of certainty, particularly as the structure relates to the residue imparted to the polymer chain end by the functionalizing agent and optionally the functionalizing agent. Indeed, it is speculated that the structure of the coupled polymer may depend upon various factors such as the conditions employed to prepare the reactive polymer (e.g., the type and amount of the catalyst or initiator) and the conditions employed to react the functionalizing agent (and optionally the functionalizing agent) with the reactive polymer (e.g., the types and amounts of the functionalizing agent and the functionalizing agent). The coupled polymer resulting from the reaction between the reactive polymer and the functionalizing agent can be protonated or further modified.

### Use of Polymer

The rubber compositions can be prepared by using the polymers of this invention alone or together with other elastomers (i.e., polymers that can be vulcanized to form compositions possessing rubbery or elastomeric properties). Other elastomers that may be used include natural and synthetic rubbers. The synthetic rubbers typically derive from the polymerization of conjugated diene monomers, the copolymerization of conjugated diene monomers with other monomers such as vinyl-substituted aromatic monomers, or the copolymerization of ethylene with one or more α-olefins and optionally one or more diene monomers.

Exemplary elastomers include natural rubber, synthetic polyisoprene, polybutadiene, polyisobutylene-co-isoprene, neoprene, poly(ethylene-co-propylene), poly(styrene-co-butadiene), poly(styrene-co-isoprene), poly(styrene-co-isoprene-co-butadiene), poly(isoprene-co-butadiene), poly(ethylene-co-propylene-co-diene), polysulfide rubber, acrylic rubber, urethane rubber, silicone rubber, epichlorohydrin rubber, and mixtures thereof. These elastomers can have a myriad of macromolecular structures including linear, branched, and star-shaped structures.

The rubber compositions may include fillers such as inorganic and organic fillers. Examples of organic fillers include carbon black and starch. Examples of inorganic fillers include silica, aluminum hydroxide, magnesium hydroxide, mica, talc (hydrated magnesium silicate), and clays (hydrated aluminum silicates). Carbon blacks and silicas are the most common fillers used in manufacturing tires. In certain embodiments, a mixture of different fillers may be advantageously employed.

In one or more embodiments, carbon blacks include furnace blacks, channel blacks, and lamp blacks. More specific examples of carbon blacks include super abrasion furnace blacks, intermediate super abrasion furnace blacks, high abrasion furnace blacks, fast extrusion furnace blacks, fine furnace blacks, semi-reinforcing furnace blacks, medium processing channel blacks, hard processing channel blacks, conducting channel blacks, and acetylene blacks.

In particular embodiments, the carbon blacks may have a surface area (EMSA) of at least 20 m²/g and in other embodiments at least 35 m²/g; surface area values can be determined by ASTM D-1765 using the cetyltrimethylammonium bromide (CTAS) technique. The carbon blacks may be in a pelletized form or an unpelletized flocculent form. The preferred form of carbon black may depend upon the type of mixing equipment used to mix the rubber compound.

The amount of carbon black employed in the rubber compositions can be up to about 50 parts by weight per 100 parts by weight of rubber (phr), with about 5 to about 40 phr being typical.

Some commercially available silicas which may be used include Hi-Sil™ 215, Hi-Sil™ 233, and Hi-Sil™ 190 (PPG Industries, Inc.; Pittsburgh, Pa.). Other suppliers of commercially available silica include Grace Davison (Baltimore, Md.), Degussa Corp. (Parsippany, N.J.), Rhodia Silica Systems (Cranbury, N.J.), and J. M. Huber Corp. (Edison, N.J.).

In one or more embodiments, silicas may be characterized by their surface areas, which give a measure of their reinforcing character. The Brunauer, Emmet and Teller (“BET”) method (described in J. Am. Chem. Soc., vol. 60, p. 309 et seq.) is a recognized method for determining the surface area. The BET surface area of silica is generally less than 450 m²/g. Useful ranges of surface area include from about 32 to about 400 m²/g, about 100 to about 250 m²/g, and about 150 to about 220 m²/g.

The pH's of the silicas are generally from about 5 to about 7 or slightly over 7, or in other embodiments from about 5.5 to about 6.8.

In one or more embodiments, where silica is employed as a filler (alone or in combination with other fillers), a silica coupling agent and/or a silica shielding agent may be added to the rubber compositions during mixing in order to enhance the interaction of silica with the elastomers. Useful silica coupling agents and silica shielding agents are disclosed in U.S. Pat. Nos. 3,842,111, 3,873,489, 3,978,103, 3,997,581, 4,002,594, 5,580,919, 5,583,245, 5,663,396, 5,674,932, 5,684,171, 5,684,172, 5,696,197, 6,608,145, 6,667,362, 6,579,949, 6,590,017, 6,525,118, 6,342,552, and 6,683,135, which are incorporated herein by reference.

The amount of silica employed in the rubber compositions can be from about 1 to about 100 phr or in other embodiments from about 5 to about 80 phr. The useful upper range is limited by the high viscosity imparted by silicas. When silica is used together with carbon black, the amount of silica can be decreased to as low as about 1 phr; as the amount of silica is decreased, lesser amounts of coupling agents and shielding agents can be employed. Generally, the amounts of coupling agents and shielding agents range from about 4% to about 20% based on the weight of silica used.

A multitude of rubber curing agents (also called vulcanizing agents) may be employed, including sulfur or peroxide-based curing systems. Curing agents are described in Kirk-Othmer, ENCYCLOPEDIA OF CHEMICAL TECHNOLOGY, VOL 20, pgs. 365-468, (3^{rd} Ed. 1982), particularly Vulcanization Agents and Auxiliary Materials, pgs. 390-402, and A. Y. Coran, Vulcanization, ENCYCLOPEDIA OF POLYMER SCIENCE AND ENGINEERING, (2^{nd} Ed. 1989), which are incorporated herein by reference. Vulcanizing agents may be used alone or in combination.

Other ingredients that are typically employed in rubber compounding may also be added to the rubber compositions. These include accelerators, accelerator activators, oils, plasticizer, waxes, scorch inhibiting agents, processing aids, zinc oxide, tackifying resins, reinforcing resins, fatty acids such as stearic acid, peptizers, and antidegradants such as antioxidants and antiozonants. In particular embodiments, the oils that are employed include those conventionally used as extender oils, which are described above.

All ingredients of the rubber compositions can be mixed with standard mixing equipment such as Banbury or Brabender mixers, extruders, kneaders, and two-rolled mills. In one or more embodiments, the ingredients are mixed in two or more stages. In the first stage (often referred to as the masterbatch mixing stage), a so-called masterbatch, which typically includes the rubber component and filler, is prepared. To prevent premature vulcanization (also known as scorch), the masterbatch may exclude vulcanizing agents. The masterbatch may be mixed at a starting temperature of from about 25° C. to about 125° C. with a discharge temperature of about 135° C. to about 180° C. Once the masterbatch is prepared, the vulcanizing agents may be introduced and mixed into the masterbatch in a final mixing stage, which is typically conducted at relatively low temperatures so as to reduce the chances of premature vulcanization. Optionally, additional mixing stages, sometimes called remills, can be employed between the masterbatch mixing stage and the final mixing stage. One or more remill stages are often employed where the rubber composition includes silica as the filler. Various ingredients including the coupled polymers of this invention can be added during these remills.

The mixing procedures and conditions particularly applicable to silica-filled tire formulations are described in U.S. Pat. Nos. 5,227,425, 5,719,207, and 5,717,022, as well as European Patent No. 890,606, all of which are incorporated herein by reference. In one embodiment, the initial masterbatch is prepared by including the coupled polymers of this invention and silica in the substantial absence of silica coupling agents and silica shielding agents.

The rubber compositions prepared from the polymers of this invention are particularly useful for forming tire components such as treads, subtreads, sidewalls, body ply skims, bead filler, and the like. For example, the polymers of this invention are employed in tread and sidewall formulations. In one or more embodiments, these tread or sidewall formulations may include from about 10% to about 100% by weight, in other embodiments from about 35% to about 90% by weight, and in other embodiments from about 50% to about 80% by weight of the polymers of this invention based on the total weight of the rubber within the formulation.

Where the rubber compositions are employed in the manufacture of tires, these compositions can be processed into tire components according to ordinary tire manufacturing techniques including standard rubber shaping, molding and curing techniques. Typically, vulcanization is effected by heating the vulcanizable composition in a mold; e.g., it may be heated to about 140° C. to about 180° C. Cured or crosslinked rubber compositions may be referred to as vulcanizates, which generally contain three-dimensional polymeric networks that are thermoset. The other ingredients, such as fillers and processing aids, may be evenly dispersed throughout the crosslinked network. Pneumatic tires can be made as discussed in U.S. Pat. Nos. 5,866,171, 5,876,527, 5,931,211, and 5,971,046, which are incorporated herein by reference.

In order to demonstrate the practice of the present invention, the following examples have been prepared and tested. The examples should not, however, be viewed as limiting the scope of the invention. The claims will serve to define the invention.

### EXAMPLES

### Examples 1-5

The following examples exemplify embodiments directed toward the lanthanide-based catalyst systems. Polymerization was conducted in 750 mL N₂-purged glass bottles. The bottles were individually charged with an approximately 20% by weight butadiene/hexane mixture and pure hexanes sufficient to prepare 333 g of a 14% by weight butadiene solution. Each bottle was charged with an appropriate amount of a 1.0 M solution of alkyl aluminum reagents per Table 1 followed by 1.64 mL of a neodymium versatate solution (0.054 M in hexanes). The bottle was allowed to rest for 3 minutes and then 0.13 mL of an ethylaluminum dichloride solution (1.09 M in hexanes) was added. The bottles were placed in an agitating bath at 80° C. After 30 minutes of agitation, the bottles were removed from the bath. The polymer was terminated by charging the polymerization mixture with 4.0 ml of a 10 wt % solution of 2,6-di-tert-butyl methylphenol in isopropanol. The polymers were coagulated in 8 L isopropanol containing 15 g of 2,6-di-tert-butyl-4-methylphenol and then drum-dried. The polymers were analyzed by Mooney, GPC, and IR with those values reported in Table 1.

TABLE 1

| Example # | 1 | 2 | 3 | 4 | 5 |
|---|---|---|---|---|---|
| Type | Control | Comparative | Comparative | Inventive | Comparative |
| DIBA/Nd | 4.22 | 0 | 0 | 4.22 | 4.22 |
| (mol/mol) | | | | | |
| TIBA/Nd | 6.33 | 0 | 0 | 0 | 0 |
| (mol/mol) | | | | | |
| TEAL/Nd | 0 | 10.00 | 20.00 | 6.33 | 0 |
| (mol/mol) | | | | | |
| % Conversion | 87.47 | 70.31 | 89.17 | 91.54 | 87.43 |
| ML₁₊₄ | 85.35 | 82.90 | 38.71 | 90.26 | 35.06 |
| T80(s) | 4.46 | 4.35 | 3.85 | 4.32 | 11.07 |
| Mn (×10³) | 320 | 247 | 135 | 295 | 325 |
| (g/mol) | | | | | |
| Mw (×10³) | 1,161 | 1,162 | 816 | 1,020 | 735 |
| (g/mol) | | | | | |
| Mw/Mn | 3.63 | 4.71 | 6.03 | 3.45 | 2.26 |
| % Cis | 98.41 | 96.66 | 92.58 | 96.75 | 95.67 |
| % Trans | 0.73 | 2.47 | 6.37 | 2.37 | 3.95 |
| % Vinyl | 0.86 | 0.86 | 1.05 | 0.88 | 0.38 |

The Mooney viscosities (ML₁₊₄) of the polymer samples were determined at 100° C. by using a Monsanto Mooney viscometer with a large rotor, a one-minute warm-up time, and a four-minute running time. The number average (Mₙ) and weight average (M_{w}) molecular weights of the polymer samples were determined by gel permeation chromatography (GPC) using a Tosoh Ecosec HLC-8320GPC system and Tosoh TSKgel GMHxl-BS columns with THF as a solvent. The system was calibrated using a series of polystyrene standards and referenced to polystyrene. The cis-1,4-linkage, trans-1,4-linkage, and 1,2-linkage contents of the polymer samples were determined by infrared spectroscopy.

As can be seen from the data in Table 1, the use of triethylaluminum (TEAL) alone (Examples 2 & 3) gives lower conversion than the control mixture of triisobutylaluminum (TIBA) and diisobutylaluminum hydride (DIBA) (Example 1). Likewise, DIBA alone (Example 5) gave lower conversion than the control mixture of TIBA and DIBA (Example 1). In contrast, the mixture of DIBA and TEAL (Example 4) gives a higher conversion than either the TIBA/DIBA mixture or TEAL alone.

### Examples 6-12

The following examples exemplify embodiments directed toward the nickel-based catalyst systems. Polymerization was conducted in 750 mL N₂-purged glass bottles. The bottles were individually charged with an approximately 20% by weight butadiene/hexane mixture and pure hexanes sufficient to prepare 300 mL of a 15% by weight butadiene solution. Each bottle was charged with an appropriate amount of a 1.0 M solution of alkyl aluminum reagents per Table 2 followed by 1.36 mL of a nickel 2-ethylhexanoate solution (0.012 M in hexanes). Then an appropriate amount of a 4.56 M solution of BF₃ and hexanol was added to yield 1.68 equivalents of B per Al (0.10-0.13 mL). The bottles were placed in an agitating bath at 80° C. After 40 minutes of agitation, the bottles were removed from the bath. The polymer was terminated by charging the polymerization mixture with 4.0 ml of a 10 wt % solution of 2,6-di-tert-butyl-4-methylphenol in isopropanol. The polymers were coagulated in 8 L isopropanol containing 15 g of 2,6-di-tert-butyl-4-methylphenol and then drum-dried. The polymers were analyzed by Mooney, GPC, and IR with those values reported in Table 2.

TABLE 2

| Example # | 6 | 7 | 8 | 9 | 10 | 11 | 12 |
|---|---|---|---|---|---|---|---|
| Type | Comparative | Inventive | Inventive | Inventive | Inventive | Inventive | Comparative |
| DIBA/Ni | 0 | 9.36 | 6.64 | 6.64 | 9.36 | 8.00 | 0 |
| (mol/mol) | | | | | | | |
| TIBA/Ni | 20.00 | 0 | 0 | 0 | 0 | 0 | 0 |
| (mol/mol) | | | | | | | |
| TEAL/Ni | 0 | 14.04 | 14.04 | 9.36 | 9.36 | 11.70 | 20.00 |
| (mol/mol) | | | | | | | |
| % Conversion | 82.0 | 84.9 | 84.4 | 82.4 | 84.0 | 82.2 | 83.3 |
| ML₁₊₄ | 57.9 | 44.5 | 36.2 | 43.5 | 44.2 | 57.2 | 48.7 |
| T80(s) | 5.78 | 6.99 | 4.10 | 7.22 | 5.74 | 5.90 | 3.99 |
| Mn (×10³) | 162 | 63 | 111 | 104 | 116 | 107 | 101 |
| (g/mol) | | | | | | | |
| Mw (×10³) | 585 | 460 | 494 | 436 | 443 | 474 | 421 |
| (g/mol) | | | | | | | |
| Mw/Mn | 3.61 | 7.34 | 4.46 | 4.18 | 3.80 | 4.43 | 4.16 |
| % Cis | 96.1 | 95.7 | 95.7 | 95.8 | 95.7 | 95.8 | 95.6 |
| % Trans | 1.63 | 1.79 | 1.87 | 1.87 | 1.86 | 1.79 | 2.03 |
| % Vinyl | 2.24 | 2.48 | 2.41 | 2.35 | 2.42 | 2.37 | 2.35 |

The Mooney viscosities (ML₁₊₄) of the polymer samples, the number average (Mₙ) and weight average (M_{w}) molecular weights of the polymer samples, and the cis-1,4-linkage, trans-1,4-linkage, and 1,2-linkage contents of the polymer samples were determined as provided above with respect to Example 1-5.

As can be seen from the data in Table 2, the use of a mixture of DIBA and TEAL gives an overall better balance of polymerization and polymer properties.

Various modifications and alterations that do not depart from the scope and spirit of this invention will become apparent to those skilled in the art. This invention is not to be duly limited to the illustrative embodiments set forth herein.

1. A method for preparing a polymer, the method comprising polymerizing conjugated diene monomer in the presence of a lanthanide-based catalyst system including:
(i) a metal compound selected from the group consisting of a lanthanide-containing compound and a nickel-containing compound,
(ii) triethyl aluminum,
(iii) an aluminum hydride, and
(iv) a halogen-containing compound.

2. The method of claim 1, where lanthanide-containing compound is selected from the group consisting of lanthanide carboxylates, lanthanide organophosphates, lanthanide organophosphonates, lanthanide organophosphinates, lanthanide carbamates, lanthanide dithiocarbamates, lanthanide xanthates, lanthanide β-diketonates, lanthanide alkoxides or aryloxides, lanthanide halides, lanthanide pseudo-halides, lanthanide oxyhalides, and organolanthanide compounds.

3. The method of claim 1, where the aluminum hydride is represented by the general formula A1RₙH₍₃₋ₙ₎, where each R independently can be a monovalent organic group that is attached to the aluminum atom via a carbon atom, and where n can be an integer in the range of from 1 to 3.

4. The method of claim 1, where the aluminum hydride is dihydrocarbylaluminum hydride.

5. The method of claim 1, where the aluminum hydride is hydrocarbylaluminum dihydride.

6. The method of claim 1, where the aluminum hydride is selected from the group consisting of diethylaluminum hydride, di-n-propylaluminum hydride, diisopropylaluminum hydride, di-n-butylaluminum hydride, diisobutylaluminum hydride, di-n-octylaluminum hydride, diphenylaluminum hydride, di-p-tolylaluminum hydride, dibenzylaluminum hydride, phenylethylaluminum hydride, phenyl-n-propylaluminum hydride, phenylisopropylaluminum hydride, phenyl-n-butylaluminum hydride, phenylisobutylaluminum hydride, phenyl-n-octylaluminum hydride, p-tolylethylaluminum hydride, p-tolyl-n-propylaluminum hydride, p-tolylisopropylaluminum hydride, p-tolyl-n-butylaluminum hydride, p-tolylisobutylaluminum hydride, p-tolyl-n-octylaluminum hydride, benzylethylaluminum hydride, benzyl-n-propylaluminum hydride, benzylisopropylaluminum hydride, benzyl-n-butylaluminum hydride, benzylisobutylaluminum hydride, and benzyl-n-octylaluminum hydride.

7. The method of claim 1, where the aluminum hydride is selected from the group consisting of ethylaluminum dihydride, n-propylaluminum dihydride, isopropylaluminum dihydride, n-butylaluminum dihydride, isobutylaluminum dihydride, and n-octylaluminum dihydride.

8. The method of claim 1, where the source of halogen is a compound selected from the group consisting of elemental halogens, mixed halogens, hydrogen halides, organic halides, inorganic halides, metallic halides, and organometallic halides.

9. The method of claim 1, where the metal compound is a lanthanide-containing compound and where the molar ratio of the triethylaluminum hydride to the lanthanide-containing compound (alkylating agent/Ln) is from about 2:1 to about 15:1.

10. The method of claim 1, where the metal compound is a lanthanide-containing compound and where the molar ratio of the hydrocarbylaluminum hydride to the lanthanide-containing compound (alkylating agent/Ln) is from about 1:1 to about 10:1.

11. The method of claim 1, where the metal compound is a lanthanide-containing compound and where the halogen/Ln molar ratio is from about 0.5:1 to about 20:1.

12. The method of claim 1, where the conjugated diene monomer is selected from the group consisting of 1,3-butadiene, isoprene, 1,3-pentadiene, 1,3-hexadiene, 2,3-dimethyl-1,3-butadiene, 2-ethyl-1,3-butadiene, 2-methyl-1,3-pentadiene, 3-methyl-1,3-pentadiene, 4-methyl-1,3-pentadiene, and 2,4-hexadiene.

13. The method of claim 1, where the metal compound is a lanthanide-containing compound and where from about 0.001 to about 2 mmol of lanthanide-compound per 100 gram of monomer is employed in said step of polymerizing.

14. The method of claim 1, where said step of polymerizing yields a polydiene, and further comprising the step of functionalizing the polydiene.

15. The method of claim 1, where further comprising the step of quenching said step of polymerizing.

16. The method of claim 1, where said step of polymerizing yields a polydiene, and where said polydiene has a cis-1,4-linkage content that is greater than 95%.

17. The method of claim 1, where said step of polymerizing yields a monomer conversion of greater than 85%.

18. The method of claim 1, where said step of polymerizing yields a monomer conversion of greater than 90%.

19. A polymer prepared by of polymerizing conjugated diene monomer in the presence of a lanthanide-based catalyst system including:
(i) a metal compound selected from the group consisting of a lanthanide-containing compound and a nickel-containing compound,
(ii) triethyl aluminum,
(iii) an aluminum hydride, and
(iv) a halogen-containing compound.

20. A tire component prepared by employing a polymer prepared by polymerizing conjugated diene monomer in the presence of a lanthanide-based catalyst system including:
(i) a metal compound selected from the group consisting of a lanthanide-containing compound and a nickel-containing compound,
(ii) triethyl aluminum,
(iii) an aluminum hydride, and
(iv) a halogen-containing compound.

21. (canceled)

22. (canceled)

23. (canceled)

24. (canceled)

25. (canceled)

26. (canceled)

27. (canceled)

28. (canceled)

29. The method of claim 1, where the metal compound is a nickel-containing compound and where the halogen-containing compound is a fluorine-containing compound.

30. The method of claim 1, where the metal compound is a nickel-containing compound and where the molar ratio of the triethylaluminum to the nickel-containing compound is from about 2:1 to about 100:1.

31. The method of claim 1, where the metal compound is a nickel-containing compound and where the molar ratio of the hydrocarbylaluminum hydride to the nickel-containing compound is from about 1:1 to about 500:1.

32. The method of claim 1, where the metal compound is a nickel-containing compound and where the F/Ni molar ratio is from about 2:1 to about 500:1.

33. (canceled)

34. The method of claim 1, where the metal compound is a nickel-containing compound and where from about 0.001 to about 2 mmol of nickel-compound per 100 gram of monomer is employed in said step of polymerizing.

35. (canceled)

36. (canceled)

37. The method of claim 1, where the metal compound is a nickel-containing compound and where the fluorine-containing compound is selected from the group consisting of elemental fluorine, halogen fluorides, hydrogen fluoride, organic fluorides, inorganic fluorides, metallic fluorides, organometallic fluorides, and mixtures thereof.

38. (canceled)

39. (canceled)

40. (canceled)

41. (canceled)

42. (canceled)
